(19) United States
(12) Patent Application Publication
(10) Pub. No.: US 2007/0254998 A1
(43) Pub. Date: Nov. 1, 2007

(54) Two-part glass ionomer composition

(76) Inventors: Jan A. Orlowski, Altadena, CA (US); David V. Butler, West Covina, CA (US); Alice Chin, Monterey Park, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/412,705

(22) Filed: Apr. 27, 2006

(51) Int. Cl. C08K 3/26

(52) U.S. Cl. 524/425; 52/432; 524/502; 524/493; 524/437; 524/432

(57) ABSTRACT

Disclosed is a novel glass ionomer type dental cement composition comprising a first component comprising an aqueous solution of polymers made from monomers comprising acrylic acid, and a second, preferably substantially anhydrous, component comprising alkaline glass flux in a medium comprising water soluble/miscible monomers or pre-polymers, of such monomers, having at least one —OH group per molecule. The compositions offer more convenient handling, excellent reproducibility of desired properties of the cured material, improved strength, and extended shelf life.

### BACKGROUND OF THE INVENTION

1. Field of the Invention

This invention relates to the field of dental cement compositions, and in particular to two-part glass ionomer compositions featuring longer shelf life, enhanced handling characteristics and improved strength.

2. Description of the Related Art

The conventional Glass Ionomer compositions represent a two-part system, one part being in a liquid form and the other in a powder form. The liquid represents a solution of oligomers or copolymers of acrylic acid. The molecular weight of such polymers is usually in the range of 40,000 to 50,000 and their concentration may vary from about 40% to 60%. The powder is composed of fine alkaline glass particles. Its chemical composition usually includes silicon and aluminum oxides, calcium fluoride, and modifying additives, which may include aluminum, sodium or barium fluorides, alkaline or alkaline earth metal oxides, aluminum phosphate and zinc, zirconium or titanium oxides.

Powder/liquid systems are the least desirable forms of self (chemically) cured dental cements and restoratives. Maintaining proper proportion of the ingredients of the cement can be critical for reproducibly achieving acceptable properties of the cured material. It is extremely difficult, however, to meet such a requirement with powder/liquid systems, considering the small quantities of materials involved in the preparation of mixes for dental applications and the imprecise tools used for dispensing such materials.

Glass ionomer compositions can be particularly sensitive to variations in proportions of its components. Dental assistants and clinicians are accustomed to other types of cements and restoratives that do not require the materials to be dispensed in a high level of precision; therefore they can have little understanding of the differences in handling requirements when glass ionomer type materials are involved as compared to other materials. Imprecise dispensing may, however, have a detrimental effect on the mechanical properties, resistance to the oral environment, curing characteristics, ability to bond to dentin and tooth enamel, and oral tissue compatibility of the cured product.

Generally, an excess of liquid in the composition will result in slower setting of materials, greater susceptibility to deterioration when exposed to saliva, and/or greater potential for oral tissue irritation. On the other hand, an excess of powder causes mixes to be too dry and may not allow for sufficient working time. The consistency of such mixes may make them unsuitable for applications where flowability of the mix is mandatory, such as in a capacity as cavity liners, orthodontic band cements and crown and bridge cements. In addition, such formulations are likely to be excessively brittle after cured and their ability to bond to the tooth structure will be impaired.

Minor variations in the characteristics of the conventional glass ionomer liquid or powder, such as variations in the molecular weight of the polyacrylic acid and particle size of the glass, may render the originally designed dispensing system unsuitable. Moreover, changes in ambient temperature influence the viscosity and surface tension of the liquid. Consequently, variations in drop sizes, when the liquid is dispensed from a conventional dropper-type bottle, may affect the powder/liquid ratio and alter the consistency of the mix. The conventional way of dispensing powder with a scoop represents an intrinsically imprecise technique, as the bulk density of the powder may vary with time due to settling and the way the powder is handled (shaking, vibration, pounding, etc.). All these factors may affect the properties and, in some instances, the safety of the material, rendering its suitability for the intended purpose questionable.

Additional problems, related to variations in the particle size of the powder may also be encountered. Manufactured powders consist of blends of different size particles. Variations in particle size distribution among different batches of commercial products are virtually unavoidable. Larger particles tend to migrate to the bottom of the container, leaving finer particles on top. Using the same dispensing method for powders consisting of different-sized particles will result in mixes of varying consistencies and unpredictable working and setting times. Smaller sized glass particles will shorten the working time and result in mixes characterized by denser consistencies.

A common characteristic of prior art glass ionomer compositions is their undesirably short working time. In order to assure desirable properties of the cured cement, mixing of the components and completion of the application procedures should be accomplished before the blend starts to show signs of setting. However, preparation of powder/liquid mixes is time consuming, leaving clinicians with little latitude to complete the application within the allowed working time. Moreover, an operator's inexperience or haste may result in the operator preparing non-homogenous mixes with negative consequences on the characteristics of the cured product.

Powder/liquid systems are also undesirable from an economic point of view because substantial waste of the material is unavoidable. Dispensing of components generally cannot be accomplished in a way that closely approximates the amount of material the clinician needs, thus a large part of the dispensed material is frequently wasted.

To alleviate the shortcomings of powder/liquid versions of glass ionomers, one solution has been offered, derived from a technique used in packaging more expensive brands of dental amalgams. Such a system is comprised of a two-compartment capsule, separated by a breakable diaphragm. One of the compartments is filled with a measured amount of the powder, and the other with the liquid component of the glass ionomer formulation.

After the diaphragm is broken, the capsule is vigorously shaken for a specified period of time, using a vibrator type machine, producing relatively homogeneous mixes of more consistent quality. Such technique eliminates some of the shortcomings of the conventionally dispensed glass ionomer compositions, assuring better reproducibility of the properties of the cured cements and simplifying handling. However, it significantly increases the cost per application and the waste. Also, handling of the material, although much easier when compared to individually dispensing the powder and liquid components, still remains complex. The working time remaining after removal of the capsules from the vibrator is still inconveniently short.

Attempts to formulate glass ionomer compositions in a form different from the conventional powder/liquid system have brought, up to now, little success. Some advantages of glass ionomers include their ability to bond to the tooth structure without the necessity of acid etching, and to protect the teeth from decay due to a sustained release of fluoride. Preservation of these characteristics, combined with the need to meet requirements related to mechanical strength, curing characteristics and safety, has imposed severe restrictions on the chemical composition, concentration and physical form of the material components. Researchers were also severely limited in their options of incorporating various additives which, although otherwise highly desirable, could have a detrimental effect on the more critical properties of the cement.

Previous efforts to change the physical form of the components of glass ionomer materials have been made in order to make them more convenient to use, some of which resulted in modifications of their chemical compositions. These new formulations, while encompassing some of the original glass ionomer's components, have differed from the original concept of glass ionomers in important aspects, including their basic chemistry and curing mechanism. Consequently, many major advantages of glass ionomers, including their ability to bond to the tooth structure, to sustain a desirable level of fluoride release, and to prevent tooth decay, were severely compromised.

Most common examples of such modified formulations comprise blends of methacrylate monomers with glass ionomer-type powders used as fillers. They represent a light-cured one-component system or a self- (chemically-) cured two component system. Their mechanism of cure relies on the chain-forming (or -lengthening) action of ethylenically unsaturated methacrylate monomers, while the curing mechanism of unadulterated glass ionomers is based on the reaction of the carboxylic group in polyacrylic acid with alkaline sites of glass powder. This distinctive mechanism of curing and the presence of water in glass ionomer formulations seemed to be key for their ability to bond to the tooth structure and to provide sustained fluoride release.

Some of the shortcomings of the prior art glass ionomer systems were addressed in U.S. Pat. No. 5,965,632 which describes a two paste glass ionomer system comprising in one part a blend of 50%-95% of an aqueous solution of polyacrylic acid, or its blends or copolymers with other ethylenically unsaturated acids, thickened with inert inorganic fillers, and the second part comprising a blend of alkaline glass with water, thickened to a desired consistency.

Although the technology of this invention provided glass ionomer compositions featuring more convenient dispensing and handling when freshly made, its shortcomings include a limited shelf life due to gradually changing consistency (thickening) of the paste containing glass powder and relatively low mechanical strength of the cured material.

Some prior publications relating to the field of this invention include U.S. Pat. No. 5,965,632 issued Oct. 12, 1999 to Jan A. Orlowski et al., U.S. Pat. No. 5,520,922 issued May 28, 1996 to Oswald Gasser and Rainer Guggenberger, U.S. Pat. No. 5,520,725 issued May 28, 1996 to Kato-Shin-Ichi et al., U.S. Pat. No. 5,382,284 issued Jan. 17, 1995 to Thomas J. Arnold, U.S. Pat. No. 5,367,002 issued Nov. 22, 1994 to Huang Chim-The et al. and U.S. Pat. No. 5,063,257 issued Nov. 5, 1991 to Akahan Shoji et al.

### SUMMARY OF THE INVENTION

In accordance with a preferred embodiment, there is provided a novel glass ionomer composition (e.g., dental cement) comprising first and second components or parts. The first part is preferably a paste or viscous liquid comprising an aqueous solution of polymers or copolymers of acrylic acid. Preferably the aqueous solution of polymers or copolymers of acrylic acid is present at 60% to 100% by weight of the total weight of the first part, and/or the polymers have molecular weights of about 35,000 to 75,000. The second part is preferably a paste comprising alkaline glass flux and water soluble/miscible monomers and/or pre-polymers (e.g. oligomers) of such monomers, having at least one —OH group per molecule. The alkaline glass flux preferably has an average particle size of about 0.2 to about 30 microns, and/or is present at about 50% to 90% by weight of the total weight of the second part. The water soluble/miscible monomers and/or pre-polymers of such monomers, having at least one —OH group per molecule are preferably present at about 10% to 50% by weight of the total weight of the second part. In a preferred embodiment, the second part further comprises one or more poly (C1-C4) alkyl methacrylate polymers, preferably polymethylmethacrylate, polyethylmethacrylate and/or copolymers of methyl- and ethyl-methacrylate, preferably having molecular weights of 100,000 to 1,500,000, and/or present at a total of up to 10% by weight, including 0.5% to 10%, 1% to 10% and 1% to 8% by weight.

In certain especially preferred embodiments, the new dental cements provide improved shelf life, strength and/or handling as compared to prior art materials, such as the two paste type glass ionomer cement described in U.S. Pat. No. 5,965,632. The present compositions preferably also allow for broad latitude in adjusting their characteristics to meet particular requirements. In one embodiment, the pastes may be dispensed by using a dual barrel type syringe device and/or blended in a static mixer attached to such a device.

Preferred embodiments herein are the result of one or more of the following unexpected and unforeseeable findings that allowed for development of glass ionomer compositions featuring desirable characteristics for the envisioned applications. One finding is the desirability of the absence, or virtual absence, of water in the part of the composition containing the glass ionomer powder. The presence of water in both parts of the prior art two paste system was deemed necessary to arrive at a workable composition featuring desirable characteristics and to meet the minimum requirements for the cured glass ionomer cement, including a sufficient range of working and curing times, adequate mechanical strength, ease of handling, longevity (shelf life), tolerance to ambient conditions, and/or resistance to oral environment. It was also desirable to preserve as many advantageous features of the conventional glass ionomer cements as possible, including their ability to bond to teeth (dentin and enamel) and to provide sustained fluoride release, for preventing the occurrence, or reoccurrence, of decays.

Another finding is the tolerance of preferred compositions to the presence of organic hydrophilic compounds at relatively high concentrations. Such compounds are employed herein as thickening and suspending agents, including in the part of the composition containing powdered alkaline glass. Unexpectedly, the presence of such a water soluble/miscible component does not substantially weaken the cured material, or cause its deterioration in a water environment. To the contrary, the cements containing such ingredients exhibit most desirable mechanical characteristics and resistance to moisture. Although not wishing to be bound by theory, it is theorized that this could be explained by the unexpected occurrence of a secondary side reaction of the unreacted group of polyacrylic acid with the hydroxy-groups of the hydrophilic additives, during the later phase of the curing process.

Furthermore, the present compositions preferably also have the ability to cure by light induced polymerization of ethylenically unsaturated components particularly acrylate and methacrylate monomers or prepolymers, in addition to the conventional glass ionomer curing mechanism of reaction between polycarboxylic acid(s) and alkaline glass.

### DETAILED DESCRIPTION OF THE PREFERRED EMBODIMENTS

Preferred embodiments as disclosed herein provide an ionomer composition comprising two components or parts, preferably in a viscous physical form, such as a paste or viscous liquid. All percentages stated herein are weight percentages based on total weight of the component in which it is present, unless otherwise stated.

The first component comprises an aqueous solution comprising polymers made from monomers comprising acrylic acid. These materials may be referred to herein as “polymers of acrylic acid” or “polymers comprising acrylic acid”, but it is to be understood that this means a polymer formed from the polymerization of monomer units, wherein the monomer units comprise acrylic acid. In some embodiments the polymer is a homopolymer and in other embodiments, other monomers may be present (such as to form a copolymer), preferably other ethylenically unsaturated acids such as itaconic acid and maleic acid, including in amounts ranging from about 1% to about 50%, including about 1% to 5%, and 5% to 10%. The first component preferably comprises about 60% to 100% by weight of an aqueous solution comprising polymers comprising acrylic acid, including about 60% to 90%, 70% to 90% or 70 to 80% by weight. In embodiments where more than one type of polymer solution is present, the stated preferred ranges correspond to the sum of the weights of each type present. The aqueous solution portion of the first component is itself a solution in which the polymer preferably makes up about 35%-70% by weight of the total weight of the aqueous solution, including about 48% to 63%, and 50% to 65% by weight. The polymers preferably have viscosity-based molecular weights in a range of about 30,000 to about 300,000, including about 30,000 to 75,000, and about 40,000 to 60,000.

In one embodiment, the polymer comprising acrylic acid may comprise an oligomer made from monomers comprising acrylic acid or a mixture of oligomers having different molecular weights. In another embodiment, the polymer comprising acrylic acid may include copolymers of acrylic acid with other ethylenically unsaturated organic acids. The oligomers comprising polyacrylic acid may be substituted, entirely or partially, by their copolymers with other ethylenically unsaturated organic acids, preferably maleic acid or itaconic acid.

In some embodiments, the first part or component contains more than one type of the polymers comprising acrylic acid. For example, the first component may comprise an aqueous solution of two or more polyacrylic acids of different molecular weights or a polyacrylic acid homopolymer and a polyacrylic acid/maleic acid copolymer. In another example, the first component can comprise an aqueous solution of two different copolymers of acrylic acid and ethylenically unsaturated organic acids, or an aqueous solution of a mixture of one kind of copolymer but present in two different molecular weights. Molecular weights referred to herein are viscosity-based molecular weights and are thus represent an aggregate or averaging of the molecular weights of the polymers in the solution said to have such molecular weight.

In some embodiments, the first component may further comprise preferably up to 30% by weight of inorganic filler (including about 1% to 30%, 5% to 25%, 10% to 25%, 10% to 20%, and 15 to 25% by weight), and/or preferably up to 10% by weight organic filler (including 1% to 10% and 2% to 8% by weight). The stated percentage ranges refer to the sum of all inorganic fillers present if one or more such fillers are present. Preferred inorganic fillers include quartz, glass, aluminum oxides, silica, and combinations thereof. Preferred organic fillers include powdered polymers such as polyethylene, polypropylene, polytetrafluoroethylene, polymethylmethacrylate, polyethylmethacrylate, nylon or any combination thereof. In one embodiment, the organic filler comprises methoxy polyethyleneglycol having a molecular weight of about 750. In another embodiment, the organic filler comprises a synthetic polypropylene wax. In addition, the first part or component of some embodiments may further comprise up to 20% by weight of tartaric acid, maleic acid, itaconic acid or any combination thereof, including 1% to 20%, 1% to 10%, and 2% to 6% by weight.

The second component preferably comprises about 50% to 90% by weight, including about 50% to 80%, 60% to 90%, 60% to 80% and 60 to 70% by weight, of a particulate glass flux (e.g., alkaline glass flux or powdered alkaline glass) in a liquid medium. The particulate glass flux preferably comprises silicon and aluminum oxides and calcium fluoride. It may optionally include one or more modifying additives, including aluminum, barium or sodium fluorides, alkaline or alkaline earth metal oxides, zirconium-, titanium- and zinc-oxides and aluminum phosphate, preferably at about 0.1% to 2% by weight including about 0.3% to 0.8%. In preferred embodiments, the alkaline glass particles have an average size of about 0.2 to about 30 microns, including about 0.2 to 4 microns.

The liquid medium portion of the second component or part preferably comprises about 10% to 50% by weight, including about 20% to 50%, 10% to 40%, 20% to 40% or 30 to 40% by weight, of a liquid medium (either a single liquid or the sum of one or more liquids). In preferred embodiments, the liquid medium is essentially anhydrous, meaning that there is no added water and preferably less than about 0.5%, including less than about 0.4%, 0.3%, 0.2%, 0.1%, 0.05, or 0.01% water by weight in the liquid medium. In other embodiments, the liquid medium contains very little water, preferably less than about 2% by weight, including less than about 1%, and about 1% to about 2%. In other embodiments, the second component may comprise more water, up to 12% water, including 2% to 10%, and 2% to 6%. The liquid medium preferably comprises water miscible acrylate or methacrylate monomers, or pre-polymers (e.g. oligomers) of such monomers, having at least one hydroxyl group per molecule. In preferred embodiments, the water miscible monomers or pre-polymers comprise hydroxyethylmethacrylate, hydroxypropylmethacrylate, glycerolmethacrylate, glyceroldimethacrylate, and combinations thereof.

In some embodiments, the second part further comprises up to 12% by weight of a total of one or more other kinds of water soluble polymers, including 2% to 12%, 2% to 10% and 1% to 8% by weight. Such materials can modify the rheological characteristics of the part and preserve homogeneity upon storage. Preferred water soluble polymers include polyalkalene glycols (e.g., polyethylene glycol and polypropylene glycol), polyalkalene-ether glycols (e.g., polytetramethylene-ether glycol) and any combination thereof. In one embodiment, the water soluble polymer comprises polytetramelylene-ether glycol having a molecular weight of about 600 to about 5,000, including about 800 to about 5,000, about 1,000 to about 5,000 and about 1,000 to about 3,000.

In still other embodiments, the second part or component comprises a total of preferably up to 10% by weight, including 0.5% to 10%, 0.5% to 7%, 1% to 10% and 1% to 8% by weight of one or more poly (C1-C4) alkyl methacrylate polymers, preferably polymethylmethacrylate, polyethylmethacrylate and/or copolymers of methyl- and ethyl-methacrylate, such polymers preferably having molecular weights of 100,000 to 1,500,000. These polymers may enhance the mechanical characteristics of the cured cement and prevent phase separation during storage. Unexpectedly, ionomer compositions disclosed herein tolerate the presence of these organic hydrophilic compounds, even at a relatively large concentration. Not only were the cured ionomer compositions of these embodiments not weakened by such additives, but, unexpectedly, they have shown advantageous mechanical characteristics and resistance to moisture. In one embodiment, inclusion of a methyl-/ethyl-methacrylate polymer increased the compressive strength of the cured material by 25% as compared to a formulation not including the polymer.

Other ingredients may be optionally incorporated in the first and/or second parts to enhance the physical properties, appearance, clinical performance, biocompatibility or shelf life of the compositions.

In some embodiments, the second component further comprises a total of preferably up to 20% by weight, including a total of 0.5% to 20%, 1% to 15%, 1% to 10% and 1% to 4%, of other ingredients. Other ingredients include suspending/thickening agents such as to achieve desirable consistency of a paste and to prevent sedimentation of the glass particles. Suspending/thickening agents include powdered inert glass, quartz, aluminum oxide, silica, zinc oxide or any combination thereof. In other embodiments, additives or other ingredients such as aluminum phosphate, sodium fluorides, barium fluorides, aluminum fluorides, alkaline or alkaline metal oxides, zinc oxide, zirconium oxide or titanium oxide may also be incorporated. Additives may have different or variable functions, such as: thickening/suspending agents, accelerators or retarders of the curing process, preservative, improving mechanical characteristics of cured material or its X-ray opacity, enhancing mineralization of teeth or their esthetics.

In some embodiments, the second part may include one or more light inducible polymerization activators, allowing for the material to cure as a result of two independent processes: (1) reaction between carboxylic acid(s) with alkaline glass, and (2) light induced polymeration of ethylenically unsaturated monomers or pre-polymers. Most frequently used polymerization activators are quinones and tertiary amines, exemplified by camphoroquinone, dimethyloaminoethyl methacrylate, triethylamine, 2-hydroxyethyl-diethylamine, triethenoloamine, and the like. In one embodiment, the second part comprises about 2% to 15% by weight, including about 5% to 10% by weight of one or more light curable monomers and/or about 0.3% to about 5% by weight, including about 1% to about 3%, of one or more light activated polymerization initiators (e.g. light inducible polymerization activator) that cause curing of monomers present in the second part. In some embodiments, the light inducible polymerization activator system may comprise 0.1 to 1% of camphoroquinone and 0.3 to 3.5% dialkylaminoalkylmethacrylate (e.g., dimethylaminoethylmethacrylate), both present in the second component.

In some embodiments, the first and second parts have different appearances, such as different or contrasting colors. Such coloration or shading can assist in achieving better control of the uniformity of the mixes. For certain dental applications, it is desirable that the cement composition after cure has an appearance resembling the color of the tooth. The requirement for various tooth color shades can be easily met by incorporating coloring agents, including pigments or dyes acceptable for intra-oral use, into one or both components. Particularly suitable coloring agents for the formulations include pigments based on iron oxides.

It is desirable, but not critical, that the two components of the system exhibit similar consistency, viscosity, and/or thixotropic behavior. This facilitates control over the ratios of the amounts dispensed and allows for using a dual barrel syringe dispensing system, including one equipped with a static mixer. Such device for dispensing the ionomer composition may offer time savings, avoidance of operator errors, and/or better control of working time, which can provide more consistent cured material characteristics. Depending on the design of a particular formulation, the first and the second components may be mixed at volumetric ratios of 1:4 to 4:1 (e.g., 1:4, 2:3, 3:2, 4:1, etc.), including at 1:1 ratio.

Examples of formulations and properties of the ionomer compositions are given below. These examples are provided for the purpose of illustration and for better understanding of the materials disclosed herein. They are presented, however, with no intention of limiting the invention as claimed.

### EXAMPLE 1

The ionomer composition was formulated as follows. The first part was a paste having the following composition:

| | |
|---|---|
| 62% aqueous solution of polyacrylic acid, MW ˜50,000 | 74% |
| Tartaric Acid | 5% |
| Quartz | 20% |
| Silica | 1% |

The second part was a paste having the following composition:

| | |
|---|---|
| Alkaline glass powder | 60% |
| Hydroxyethylmethacrylate | 33% |
| Polytetramethylene-ether glycol, MW ˜2,000 | 6% |
| Silica | 1% |

These two pastes were simultaneously dispensed in volumetrically equal proportions from a dual barrel syringe unit equipped with a static mixer. At 23° C., the working time of the mix was 90 seconds, and the setting time was 3.5 minutes. The compressive strength after cure was 64-71 MPa after 72 hours exposure to 37° C. at 100% humidity. The material in its uncured form has shown no signs of changes upon storage and the properties of the cured cement made from such aged compositions have also remained unchanged.

### EXAMPLE 2

The ionomer composition was formulated as follows. The first part was a paste having the following composition:

| | |
|---|---|
| 50% aqueous solution of polyacrylic acid, MW ˜45,000 | 40% |
| 65% aqueous solution of polyacrylic acid, MW ˜50,000 | 40% |
| Polyacrylic acid, MW ˜100,000 | 1.5% |
| Quartz | 17% |
| Silica | 1.5% |

The second part was a paste having the following composition:

| | |
|---|---|
| Alkaline glass powder (<10μ) | 66% |
| Hydroxyethylmethacrylate | 24% |
| Polytetramethylene-ether glycol, MW ˜1,000 | 8.0% |
| Silica | 1.5% |

These two pastes were mixed together in volumetrically equal proportions. At 23° C., the working time of the mix was 90 seconds, and the setting time was 210 seconds. The compressive strength of the material after exposure for 24 hours at 37° C. to 100% humidity was in excess of 65 MPa. The consistencies of the pastes allowed for easy dispensing from dual barrel syringes equipped with a static mixer. The pastes did not show any phase separation, changes in color or consistency after 1 month of storage at 37° C.

### EXAMPLE 3

The ionomer composition was formulated as follows. The first part was a paste having the following composition:

| | |
|---|---|
| 63% aqueous solution of polyacrylic acid, MW ˜48,000 | 76% |
| Silica | 2% |
| Fused quartz (<20μ) | 20% |
| Methoxypolyethyleneglycol, MW ˜750 | 2% |

The second part was a paste having the following composition:

| | |
|---|---|
| Alkaline glass powder | 60% |
| Hydroxypropylmethacrylate | 32% |
| Polytetramethylene-ether glycol, MW ˜2,000 | 4% |
| Silica | 1.6% |
| Quartz | 2.4% |

These two pastes were mixed together in volumetrically equal proportions. At 23° C., the working time of the mix was 100 seconds, and the setting time was 240 seconds. The pastes remained unchanged after storage for 14 weeks at 23° C.

### EXAMPLE 4

The ionomer composition was formulated as follows. The first part was a paste having the following composition:

| | |
|---|---|
| 50% aqueous solution of polyacrylic acid, MW ˜50,000 | 75% |
| Tartaric acid | 4% |
| Synthetic polypropylene wax | 8% |
| Fused quartz (<20μ) | 13% |

The second part was a paste having the following composition:

| | |
|---|---|
| Alkaline glass powder (<10μ) | 61% |
| Hydroxyethylmethacrylate | 33% |
| Polytetramethylene-ether glycol, MW ˜3,000 | 3.5% |
| Silica | 1.5% |
| Germaben II (a preservative) | 0.5% |
| Zinc oxide | 0.5% |

The two pastes were mixed together in volumetrically equal proportions. At 23° C., the working time of the mix was 130 seconds, and the setting time was 240 seconds. Both pastes were stable upon storage at room temperature with respect to their consistencies and curing characteristics.

### EXAMPLE 5

The glass ionomer composition was formulated as follows. The first part was a paste having the following composition:

| | |
|---|---|
| 48% solution of polyacrylic acid, MW ˜50,000 | 80% |
| Tartaric acid | 2% |
| Silica | 3% |
| Fused quartz (<20μ) | 15% |

The second part was a paste having the following composition:

| | |
|---|---|
| Alkaline glass powder (<4μ) 64% | 66% |
| Hydroxyethylmethacrylate | 31% |
| Methyl-/ethyl- methacrylate, copolymer, MW ˜600,000 | 1.5% |
| Silica | 1.5% |

These two pastes were mixed in volumetrically equal proportions. At 23° C., the working time was 150 seconds and the setting time was 300 seconds. The compressive strength of the material after exposure for 24 hours at 37° C. to 100% humidity was in excess of 125 Mpa. The consistency allowed for easy dispensing from dual barrel syringes equipped with a static mixer.

### EXAMPLE 6

The ionomer composition that provides a dual light/chemical curing mechanism was formulated as follows. The first part was a paste having the following composition:

| | |
|---|---|
| 60% aqueous solution of polyacrylic acid, MW ˜58,000 | 75% |
| Quartz | 20% |
| Tartaric acid | 5% |

The second part was a paste having the following composition:

| | |
|---|---|
| Alkaline glass powder (<10μ) | 60% |
| Polytetramethylene-ether glycol, MW ˜2,000-3,000 | 2.5% |
| Silica | 4% |
| Hydroxyethyl methacrylate | 22% |
| 7,7,9-trimethyl-4,13 dioxo,3,4-dioxa-5,12 diaza-hexedecan-1,6- | 9.5% |
| diol dimethacrylate (common name: diurethane dimethacrylate) | |
| Camphoroquinone | 0.5% |
| Dimethylaminoethyl methacrylate | 1.5% |

The two pastes were mixed together in volumetrically equal proportions. At 23° C., the working time was 140 seconds, and the setting time was 300 seconds. When the mix was irradiated for 40 seconds using an Optilux 500™ dental curing light, the cured material was less brittle than its self cured only counterpart and a significant decrease in its solubility was also noticed, indicating the occurrence of polymerization of unreacted ethylenically unsaturated components.

The various compositions and methods described above provide a number of ways to carry out certain preferred embodiments. Of course, it is to be understood that not necessarily all objectives or advantages described may be achieved in accordance with any particular embodiment described or claimed herein. Thus, for example, those skilled in the art will recognize that the compositions may be made and the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments. Similarly, the various components and features discussed above, as well as other known equivalents for each such component or feature, can be mixed and matched by one of ordinary skill in this art to make compounds and perform methods in accordance with principles described herein.

Although the invention has been disclosed in the context of certain embodiments and examples, it will be understood by those skilled in the art that the invention extends beyond these specifically disclosed embodiments to other alternative embodiments and/or uses and obvious modifications and equivalents thereof. Accordingly, the invention is not intended to be limited by the specific disclosures of preferred embodiments herein.

1. A curable glass ionomer composition comprising:
a first part, in the form of a paste or viscous liquid, comprising 60% to 100% by weight of an aqueous solution of polymers or copolymers of acrylic acid; and
a second part in the form of a paste comprising 50% to 90% by weight alkaline glass flux and 10% to 50% by weight of a medium comprising water soluble/miscible monomers or pre-polymers having at least one hydroxyl (—OH) group per molecule.

2. The glass ionomer composition of claim 1, wherein said aqueous solution has a polymer concentration of 35% to 70%.

3. The glass ionomer composition of claim 1, wherein said aqueous solution comprises at least one type of polymer or copolymer having a molecular weight of about 30,000 to 75,000.

4. The glass ionomer composition of claim 3, wherein said aqueous solution comprises a second polymer comprising polyacrylic acid having a molecular weight of about 75,000 to about 300,000.

5. The glass ionomer composition of claim 4, wherein said second polymer is present in an amount of 2-25% by weight.

6. The glass ionomer composition of claim 1, wherein the alkaline glass flux has an average particle size of about 0.2 to about 30 microns,

7. The glass ionomer composition of claim 1, wherein the first part further comprises up to 30% by weight of an inorganic filler comprising quartz, glass, aluminum oxide, silica, or any combination thereof.

8. The glass ionomer composition of claim 1, wherein the first part further comprises up to 10% by weight of an organic filler comprising powdered polyethylene, polypropylene, polytetrafluoroethylene, polymethylmethacrylate, polyethylmethacrylate, nylon or any combination thereof.

9. The glass ionomer composition of claim 1, wherein the first part further comprises up to 20% by weight of tartaric acid, maleic acid, itaconic acid or any combination thereof.

10. The glass ionomer composition of claim 1, wherein at least one of said polymers comprising acrylic acids is a copolymer of acrylic acids and ethylenically unsaturated organic acids.

11. The glass ionomer composition of claim 10, wherein said ethylenically unsaturated organic acids are selected from the group consisting of maleic acid, itaconic acid and a combination thereof.

12. The glass ionomer composition of claim 1, wherein said water soluble/miscible monomer or pre-polymer are selected from the group consisting of hydroxyethylmethacrylate, hydroxypropylmethacrylate, glycerol methacrylate, glycerol dimethacrylate, and any combination thereof.

13. The glass ionomer composition of claim 1, wherein said water soluble/miscible monomer or pre-polymer is hydroxyethylmethacrylate.

14. The glass ionomer composition of claim 1, wherein said second part further comprises 2% to 12% by weight of polyalkalene glycol, polyalkalene-ether glycol or any combination thereof.

15. The glass ionomer composition of claim 1, wherein said second part further comprises 2% to 12% by weight of polytetramethylene-ether glycol having a molecular weight of about 600 to about 5,000.

16. The glass ionomer composition of claim 1, wherein said alkaline glass flux comprises calcium fluoroaluminosilicate alkaline glass powder.

17. The glass ionomer composition of claim 1, wherein said second part further comprises up to 20% by weight of powdered inert glass, quartz, aluminum oxide, silica, zinc oxide, calcium silicate, or any combination thereof.

18. The glass ionomer of claim 1, wherein said second part comprises polymethyl methacrylate, polyethyl methacrylate, their copolymers and/or mixtures thereof.

19. The glass ionomer of claim 1, wherein said second part further comprises up to 10% by weight of C₁-C₄ alkyl methacrylate polymers having molecular weight of 100,000 to 1,500,000.

20. The glass ionomer of claim 19, wherein said C₁-C₄ alkyl methacrylate polymers comprise polymethyl methacrylate, polyethyl methacrylate, their copolymers and/or mixtures thereof.

21. The glass ionomer composition of claim 1, wherein said second part further comprises light inducible polymerization activator.

22. The glass ionomer composition of claim 17, wherein said polymerization activator comprises quinones and tertiary amines.

23. The glass ionomer composition of claim 18, wherein said polymerization activator comprises 0.1% to 1% by weight of camphoroquinone.

24. The glass ionomer composition of claim 18, wherein said polymerization activator is dialkyaminoalkylmethacrylate.

25. The glass ionomer composition of claim 1, wherein said first part or said second part further comprises up to 10% by weight of barium sulfate.

26. The glass ionomer composition of claim 1, wherein said first and said second parts are mixed in proportions from 1:4 to 4:1.

27. The glass ionomer composition of claim 1, wherein said first and said second parts have different appearance.

28. The glass ionomer composition of claim 1 having a color resembling a tooth after curing.

29. An glass ionomer composition comprising:
a first part, in the form of a paste or viscous liquid, comprising 60% to 100% by weight of an aqueous solution of polymers comprising acrylic acids, wherein said polymers have molecular weights of about 35,000 to 75,000; and
a second part in the form of a paste comprising 50% to 90% by weight of alkaline glass flux having an average particle size of about 0.2 to about 30 microns, and 10% to 50% by weight of a medium comprising water soluble/miscible monomer or pre-polymer having at least one —OH group per molecule.

30. An glass ionomer composition comprising:
a first part, in the form of a paste or viscous liquid, comprising 60% to 100% by weight of an aqueous solution of polymers comprising acrylic acids; and
a second part in the form of a paste comprising 50% to 90% by weight of alkaline glass flux, 10% to 50% by weight of a medium comprising water soluble/miscible monomer or pre-polymer having at least one —OH group per molecule, and 1 to 10% by weight of one or more C₁-C₄ alkyl methacrylate polymers or copolymers.

31. The glass ionomer of claim 30, wherein said C₁-C₄ alkyl methacrylate polymers comprise polymethyl methacrylate, polyethyl methacrylate, their copolymers and/or mixtures thereof.

32. A unit comprising a two compartment dispenser, the first compartment filled with the first part and a second compartment filled with the second part of the glass ionomer composition of claim 1

33. The unit of claim 26 further comprising static mixers attachable to such dispenser.

34. The unit of claim 26 comprising a dual barrel syringe, wherein a first barrel is filled with said first part and a second barrel is filled with said second part.
